(19) United States
(12) Patent Application Publication
(10) Pub. No.: US 2023/0050689 A1
(43) Pub. Date: Feb. 16, 2023

(54) A Method To Synthesize A Porous Carbon-Sulfur Composite Cathode For A Sodium-Sulfur Battery

(71) Applicant: Agency for Science, Technology and Research, Singapore (SG)

(72) Inventors: Yong WANG, Singapore (SG); Yong Sheng Alex ENG, Singapore (SG); Zhi Wei SEH, Singapore (SG)

(21) Appl. No.: 17/779,547

(22) PCT Filed: Nov. 27, 2020
(86) PCT No.: PCT/SG2020/050699

§ 371 Date: May 24, 2022

(30) Foreign Application Priority Data
Nov. 29, 2019 (SG) 10201911398V

(51) Int. Cl. H01M 4/583; H01M 4/04; H01M 4/36; H01M 4/62; H01M 4/66; H01M 4/38; H01M 10/39

(52) U.S. Cl. CPC H01M 4/583; H01M 4/0471; H01M 4/362; H01M 4/622; H01M 4/625; H01M 4/0404; H01M 4/667; H01M 4/661; H01M 4/663; H01M 4/382; H01M 10/3909; H01M 2004/028

(57) ABSTRACT

There is provided a method of synthesizing a porous carbon-sulfur composite comprising the step of carbonizing a carbon material having a metal-organic framework (MOF) at a temperature of 800-1000° C. to produce a porous carbon, mixing and heating the porous carbon with sulfur to infuse the sulfur (melt diffusion) into the pores of the porous carbon and removing excess sulfur not infused into the pores or present on the surface of the porous carbon. There is also provided a cathode comprising the porous carbon-sulfur composite and a method of preparing the cathode by mixing with conductive carbon and a polymer binder. The cathode finds use in an electrochemical cell comprising a sodium or lithium anode.

### REFERENCES TO RELATED APPLICATIONS

This application claims priority to Singapore application number 10201911398V filed on 29 Nov. 2019, the disclosure of which is hereby incorporated by reference.

### TECHNICAL FIELD

The present invention generally relates to a method of synthesizing a porous carbon-sulfur composite and the porous carbon-sulfur composite made according to the methods as defined herein. The present invention also relates to a cathode comprising the porous carbon-sulfur composite and a method of preparing the cathode. The present invention further relates to an electrochemical cell.

### BACKGROUND ART

Owing to their low cost and high energy density, rechargeable room-temperature sodium-sulfur batteries have attracted much attention in the past few years. However, the critical challenges of low reversible capacity and fast capacity fading in the presence of a highly reactive sodium anode hinder their commercial applications. To overcome these problems, porous carbon can be used to encapsulate and confine sulfur within the pores. In this case, sulfur exists as insoluble short-chain allotropes (S₂₋₄), unlike bulk sulfur (S₈) and long-chain polysulfides which can dissolve into the electrolyte and consequently react with sodium.

Conventional methods of producing porous carbon encapsulating sulfur within the pores of the porous carbon includes carbonization of zeolitic imidazolate framework-8 by heating at 1000° C. for 8 hours, which is highly hazardous and energy-wasting. Sulfur is then infused into the pores using melt diffusion, which leaves residual sulfur on the surface of the porous carbon, leading to poor specific capacity when the porous carbon is used as a cathode in an electrochemical cell.

Another method of preparing the porous carbon includes carbonization at 1000° C. using sulphuric acid, which is highly hazardous and energy-wasting. After infusing the sulfur, the residual sulfur on the surface of the porous carbon is removed in a closed system, which is not able to fully remove the sulfur on the surface, thus leading to the same problem as mentioned above.

Accordingly, there is a need for a method of making a sulfur infused porous carbon that ameliorates one or more disadvantages mentioned above.

### SUMMARY

In one aspect, there is provided a method of synthesizing a porous carbon-sulfur composite, comprising the steps of: (a) carbonizing a carbon material having a metal-organic framework at a temperature in the range of 800° C. to 1000° C. to produce a porous carbon; (b) mixing and heating the porous carbon with sulfur to infuse the sulfur into the pores of the porous carbon; and (c) removing excess sulfur not infused into the pores or present on the surface of the porous carbon.

Advantageously, the carbonizing step (a) may be performed at a temperature less than 1000° C., which saves energy and results in high battery performance.

Further advantageously, the removing step (c) may fully remove sulfur on the surface of the porous carbon, which leads to enhanced cycling stability in sodium-sulfur batteries.

In another aspect, there is provided a porous carbon-sulfur composite synthesized by the method as described herein.

In another aspect, there is provided a cathode comprising the porous carbon-sulfur composite as described herein.

In another aspect, there is provided a method of preparing the cathode as described herein, comprising: (a) mechanically treating a mixture comprising the porous carbon-sulfur composite as described herein, a conductive carbon, and a polymer binder; (b) adding an organic solvent into the mixture to yield a slurry; and (c) coating the slurry onto a carbon-coated aluminium foil.

In another aspect, there is provided an electrochemical cell comprising: (a) the cathode as described herein; (b) an anode; and (c) an electrolyte in fluid communication with both said cathode and said anode.

Advantageously, the electrochemical cell may have high battery performance and cycling stability due to the low temperature used to prepare the porous carbon and the complete removal of sulfur on the surface of the porous carbon.

Definitions

The following words and terms used herein shall have the meaning indicated:

The term “porous” as used herein when applied to a material is to be interpreted broadly as referring to a material that has pores with a mean effective pore diameter in the range of about 0.1 nm to about 50 nm, and total surface area in the range of about 10 m²/g to about 1500 m²/g as determined by the Brunauer-Emmett-Teller (BET) method.

The term “carbonizing” as used herein refers to a method of heating an organic material at a temperature of at least 800° C. to reduce the content of non-carbon elements.

The term “heating rate” as used herein refers to a rate at which a temperature is increased as a result of heating. A higher heating rate means a faster rise in the temperature of the heated object.

The term “open system” as used herein refers to a state of an object in which it is connected to ambient atmosphere. In the open system, a gaseous substance in the object may diffuse into ambient atmosphere and be removed from the object.

The term “flow rate” as used herein refers to a volume of gas that flows through an object in a certain time period. It is measured in the unit of “standard cubic centimeters per minute” (sccm) in the present disclosure.

The term “coulombic efficiency” as used herein refers to an efficiency at which electrons are transferred in an electrochemical cell. The electrochemical cell may have higher efficiency when less heat is generated by it or when there are fewer reactions which are irrelevant to the working of the cell.

The term “specific capacity” as used herein refers to a quantity of energy of a battery having a certain quantity of mass. It is measured in the unit of “milliampere-hours per gram” (mAh/g) in the present disclosure. The battery with a higher specific capacity may produce more energy at a lower weight.

The term “2032-type coin cells” as used herein refers to a type of button cells with 20 mm diameter and 3.2 mm height.

The word “substantially” does not exclude “completely” e.g. a composition which is “substantially free” from Y may be completely free from Y. Where necessary, the word “substantially” may be omitted from the definition of the invention.

Unless specified otherwise, the terms “comprising” and “comprise”, and grammatical variants thereof, are intended to represent “open” or “inclusive” language such that they include recited elements but also permit inclusion of additional, unrecited elements.

The term “about” as used herein typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and subgeneric groupings falling within the generic disclosure also form part of the disclosure. This includes the generic description of the embodiments with a proviso or negative limitation removing any subject matter from the genus, regardless of whether or not the excised material is specifically recited herein.

### DETAILED DISCLOSURE OF EMBODIMENTS

Exemplary, non-limiting embodiments of a method of synthesizing a porous carbon-sulfur composite will now be disclosed.

The method comprises the steps of: (a) carbonizing a carbon material having a metal-organic framework at a temperature in the range of 800° C. to 1000° C. to produce a porous carbon; (b) mixing and heating the porous carbon with sulfur to infuse the sulfur into the pores of the porous carbon; and (c) removing excess sulfur not infused into the pores or present on the surface of the porous carbon.

In the method, the carbonizing step (a) may comprise heating the carbon material having a metal-organic framework at a temperature that is at least about 800° C. and less than about 1000° C.; preferably at least about 850° C. and less than about 1000° C.; more preferably at least about 900° C. and less than about 1000° C.; most preferably about 900° C. Heating at the temperature of at least about 900° C. to less than 1000° C. results in a better battery performance and may avoid the need for an additional step of removing impurity by treating with an acid.

The temperature of the carbonizing step may be reached at a heating rate of about 1.5° C. min⁻¹ to about 2.5° C. min⁻¹; about 2.0° C. min⁻¹ to about 2.5° C. min⁻¹ or about 1.5° C. min⁻¹ to about 2.0° C. min⁻¹. In a preferred embodiment, the heating rate is about 2.0° C. min⁻¹.

The heating of the carbon material having the metal-organic framework may be undertaken in a time period in the range of about 2 hours to about 8 hours; about 4 hours to about 8 hours; about 6 hours to about 8 hours; about 2 hours to about 6 hours or about 2 hours to about 4 hours at said temperature. The time period may be about 4 hours.

In the carbonizing step (a), the metal-organic framework used is not particularly limited and exemplary metal-organic frameworks may be zeolite-type metal-organic frameworks, micro-porous metal-organic framework (MMOFs), porous coordination networks (PCNs) or porous coordination polymers (PCPs). The metal-organic framework may be a zeolite-type metal-organic framework.

The zeolite-type metal-organic frameworks used are not particularly limited and exemplary zeolite-type metal-organic frameworks may be zeolitic imidazolate framework-3 (ZIF-3), zeolitic imidazolate framework-6 (ZIF-6), zeolitic imidazolate framework-8 (ZIF-8), zeolitic imidazolate framework-11 (ZIF-11), zeolitic imidazolate framework-14 (ZIF-14), zeolitic imidazolate framework-20 (ZIF-20), zeolitic imidazolate framework-60 (ZIF-60), zeolitic imidazolate framework-68 (ZIF-68) or zeolitic imidazolate framework-95 (ZIF-95). The zeolite-type metal-organic framework may be ZIF-8. The metal-organic framework ZIF-8 may comprise zinc as the metal component and imidazole as the organic component. Advantageously, when ZIF-8 is heated at a temperature in the range as described above, the zinc metal present in the ZIF-8 can be completely removed by evaporation, thereby improving the battery performance.

The method may further comprise a step of mechanically treating the carbon material having the metal-organic framework before the carbonizing step (a). The mechanically treating step may make the carbon material into fine or smaller powders, which allows for uniform and efficient heating in the carbonizing step (a).

In the mechanically treating step, the method of mechanically treating is not particularly limited and exemplary methods may be cutting, grinding, shearing, chopping or combinations thereof.

In one embodiment, the method may not comprise a washing step after the carbonizing step (a) and before the mixing and heating step (b). Advantageously, the carbonizing step may remove metal impurities from the metal-organic framework by heating at the temperature of at least about 900° C. to less than 1000° C. Therefore, by selecting the heating temperature for the carbonizing step (a), this may avoid the need for an additional washing step.

After the carbonizing step (a), the porous carbon produced may comprise pores with mean effective pore diameters in the range of about 0.1 nm to about 2 nm; about 0.5 nm to about 2 nm; about 1 nm to about 2 nm; about 1.5 nm to about 2 nm; about 0.1 nm to about 1.5 nm; about 0.1 nm to about 1 nm or about 0.1 nm to about 0.5 nm.

The sulfur in the mixing and heating step (b) may be elemental sulfur S₈ or short-chain sulfur allotropes S₂, S₃ or S₄.

The sulfur in the mixing and heating step (b) may be elemental sulfur S₈. The elemental sulfur S₈ may be converted to short-chain sulfur allotropes S₂, S₃ or S₄ in the mixing and heating step (b).

In the mixing and heating step (b), the short-chain sulfur allotropes S₂, S₃ or S₄ may be infused into the pores. The elemental sulfur S₈ may remain on the surface of the porous carbon.

Short-chain sulfur allotropes may not exist outside the porous carbon or be isolated under ambient conditions due to their instability. Thus, a combination of characterization methods, comprising X-ray diffraction (XRD), thermogravimetric analysis (TGA), and elemental combustion analysis, may be needed to infer the presence of short-chain allotropes.

In the mixing and heating step (b), the sulfur and the porous carbon may be provided in a weight ratio in the range of about 5:1 to about 1:1; about 4:1 to about 1:1; about 3:1 to about 1:1; about 2:1 to about 1:1; about 5:1 to about 2:1; about 5:1 to about 3:1 or about 5:1 to about 4:1. The weight ratio of the sulfur to the porous carbon may be about 3:1.

The mixing and heating step (b) may comprise physically mixing the porous carbon and the sulfur to provide a carbon-sulfur mixture thereof. In the physically mixing step, the method of mixing is not particularly limited and exemplary methods may be shaking, swirling, grinding or combinations thereof of the carbon-sulfur mixture. In one embodiment, the method of mixing is grinding using a pestle and a mortar.

The physically mixing step may further comprise a step of enclosing the carbon-sulfur mixture in a sealed vessel before mixing. Advantageously, having the carbon-sulfur mixture enclosed in a sealed vessel may aid to increase the amount of sulfur that is infused into the pores in the mixing and heating step.

The mixing and heating step may comprise heating the carbon-sulfur mixture at a temperature in the range of about 100° C. to about 200° C.; about 150° C. to about 200° C. or about 100° C. to about 150° C. The temperature may be about 155° C.

The mixing and heating step may comprise heating the carbon-sulfur mixture in a time period in the range of about 12 hours to about 20 hours; about 14 hours to about 20 hours;

about 16 hours to about 20 hours; about 18 hours to about 20 hours; about 12 hours to about 18 hours; about 12 hours to about 16 hours or about 12 hours to about 14 hours at the temperature described herein. The time period may be about 16 hours.

In the method, the removing step (c) may comprise removing excess sulfur that are not infused into the pores of the porous carbon or excess sulfur present on the surface of the porous carbon under an inert gas flow in an open system. Advantageously, non-carbon elements in the porous carbon may be removed by the inert gas flow in the open system.

The inert gas used is not particularly limited and exemplary inert gases may be argon, helium, neon, xenon, nitrogen and combinations thereof.

The inert gas flow may have a flow rate of the inert gas in the range of about 100 sccm to about 300 sccm; about 150 sccm to about 300 sccm; about 200 sccm to about 300 sccm; about 250 sccm to about 300 sccm; about 100 sccm to about 250 sccm; about 100 sccm to about 200 sccm or about 100 sccm to about 150 sccm. The flow rate of the inert gas may be about 200 sccm.

The removing step (c) may comprise heating the porous carbon at a temperature in the range of about 200° C. to about 300° C.; about 220° C. to about 300° C.; about 240° C. to about 300° C.; about 260° C. to about 300° C.; about 280° C. to about 300° C.; about 200° C. to about 280° C.; about 200° C. to about 260° C.; about 200° C. to about 240° C. or about 200° C. to about 220° C. The temperature used in the removing step (c) may be about 250° C. At 250° C., the excess sulfur on the surface of the porous carbon may be in a gaseous state which can be removed by the inert gas flow in the open system.

In the ranges of temperatures described above, the excess elemental sulfur that has not been converted to short-chain sulfur allotropes S₂, S₃ or S₄ and remained on the surface of the porous carbon may be evaporated from the surface of said porous carbon and subsequently become removed by the inert gas flow.

Therefore, the sulfur infused into the pores of the porous carbon in step (b) is short-chain sulfur allotropes S₂, S₃ or S₄ and the excess sulfur not infused into the pores or present on the surface of the porous carbon in step (c) is elemental sulfur S₈.

The heating of the porous carbon during the removing step (c) may be undertaken in a time period in the range of about 2 hours to about 5 hours; about 3 hours to about 5 hours; about 4 hours to about 5 hours; about 2 hours to about 4 hours or about 2 hours to about 3 hours. The time period may be about 3 hours.

Exemplary, non-limiting embodiments of a porous carbon-sulfur composite will now be disclosed. The composite is synthesized by the method as described herein.

The composite may have a weight percentage of sulfur in the range of about 30 weight % to about 40 weight %; about 32 weight % to about 40 weight %; about 34 weight % to about 40 weight %; about 36 weight % to about 40 weight %; about 38 weight % to about 40 weight %; about 30 weight % to about 38 weight %; about 30 weight % to about 36 weight %; about 30 weight % to about 34 weight % or about 30 weight % to about 32 weight % based on the weight of the porous carbon-sulfur composite. The weight percentage of sulfur may be about 36 weight %. In the composite, the sulfur may consist essentially of short-chain sulfur allotropes S₂, S₃, S₄ or combinations thereof. In the composite, the sulfur may consist of short-chain sulfur allotropes S₂, S₃, S₄ or combinations thereof.

The composite may be substantially free of elemental sulfur, where the weight % of elemental sulfur present in the composite is about 0 weight % to about 0.5 weight %, based on the weight of the porous carbon-sulfur composite. The weight % of elemental sulfur present in the composite may be about 0 weight %.

The composite may have a weight ratio of carbon and nitrogen in the range of about 20:1 to about 3:1; about 15:1 to about 3:1; about 9:1 to about 3:1; about 8:1 to about 3:1; about 20:1 to about 8:1; about 20:1 to about 9:1 or about 20:1 to about 15:1. The weight ratio of carbon and nitrogen may be in the range of about 9:1 to about 8:1.

Exemplary, non-limiting embodiments of a cathode will now be disclosed.

The cathode may comprise the porous carbon-sulfur composite as described herein.

In the cathode, sulfur contents may consist essentially of short-chain sulfur allotropes S₂, S₃, S₄ or combinations thereof. In the composite, sulfur contents may consist of short-chain sulfur allotropes S₂, S₃, S₄ or combinations thereof.

Exemplary, non-limiting embodiments of a method of preparing the cathode as described herein will now be disclosed.

The method may comprise the steps of: (a) mechanically treating a mixture comprising the porous carbon-sulfur composite as described herein, a conductive carbon, and a polymer binder; (b) adding an organic solvent into the mixture to yield a slurry; and (c) coating the slurry onto a carbon-coated aluminium foil.

The method may comprise the steps of:

(a1) carbonizing a carbon material having a metal-organic framework at a temperature in the range of 800° C. to 1000° C. to produce a porous carbon;

(a2) mixing and heating the porous carbon with sulfur to infuse said sulfur into the pores of said porous carbon;

(a3) removing excess sulfur not infused into the pores or present on the surface of said porous carbon to thereby produce a porous carbon-sulfur composite;

(a) mechanically treating a mixture comprising the porous carbon-sulfur composite produced from step (a3), a conductive carbon, and a polymer binder;

(b) adding an organic solvent into the mixture to yield a slurry; and

(c) coating the slurry onto a carbon-coated aluminium foil.

The mechanically treating step (a) may comprise mixing the porous carbon-sulfur composite, the conductive carbon and the polymer binder.

In the mechanically treating step (a), the porous carbon-sulfur composite and the conductive carbon may be provided in a weight ratio of about 1:1 to about 20:1, about 5:1 to about 20:1, about 10:1 to about 20:1, about 15:1 to about 20:1, about 1:1 to about 15:1, about 1:1 to about 10:1 or about 1:1 to about 5:1.

In the mechanically treating step (a), the porous carbon-sulfur composite and the polymer binder may be provided in a weight ratio of about 1:1 to about 20:1, about 5:1 to about 20:1, about 10:1 to about 20:1, about 15:1 to about 20:1, about 1:1 to about 15:1, about 1:1 to about 10:1 or about 1:1 to about 5:1.

In the mechanically treating step (a), the porous carbon-sulfur composite, the conductive carbon and the polymer binder may be provided at a weight ratio of about 7:2:1

The polymer binder may function to bind the porous carbon-sulfur composite and conductive carbon to form a solid electrode. The polymer binder is not particularly limited and exemplary polymer binders may be polyvinylidene fluoride, polyacrylic acid, polyvinyl alcohol, carboxymethyl cellulose, sodium alginate, sodium carboxymethyl chitosan, styrene butadiene rubber, or combinations thereof. The polymer binder may be polyvinylidene fluoride.

The adding step (b) may further comprise stirring the slurry overnight.

The coating step (c) may further comprise drying of the coating formed.

The drying step in the coating step (c) may be performed overnight.

The drying step in the coating step (c) may be performed under a temperature in the range of about 40° C. to about 80° C.; about 50° C. to about 80° C.; about 60° C. to about 80° C.; about 70° C. to about 80° C.; about 40° C. to about 70° C.; about 40° C. to about 60° C. or about 40° C. to about 50° C. The drying step may be performed at the temperature of 60° C.

Exemplary, non-limiting embodiments of an electrochemical cell will now be disclosed.

The electrochemical cell comprises (a) the cathode as described herein; (b) an anode; and (c) an electrolyte in fluid communication with both said cathode and said anode.

The electrochemical cell may further comprise a separator. The separator may comprise a polymer membrane having a thickness in the range of about 10 μm to about 50 μm, about 20 μm to about 50 μm, about 30 μm to about 50 μm, about 40 μm to about 50 μm, about 10 μm to about 40 μm, about 10 μm to about 30 μm or about 10 μm to about 20 μm.

The polymer membrane may have pores with a mean effective pore diameter in the range of about 50 nm to about 300 nm, about 100 nm to about 300 nm, about 150 nm to about 300 nm, about 200 nm to about 300 nm, about 250 nm to about 300 nm, about 50 nm to about 250 nm, about 50 nm to about 200 nm, about 50 nm to about 150 nm or about 50 nm to about 100 nm.

The polymer membrane may have pores with pore densities in the range of about 30% to 50%, about 35% to 50%, about 40% to 50%, about 45% to 50%, about 30% to 45%, about 30% to 40% or about 30% to 35%.

The polymer in the polymer membrane is not particularly limited and exemplary polymers may be polyethylene, polypropylene, polyvinylidene fluoride or combinations thereof.

The separator may be a Celgard membrane.

The anode (b) may be a sodium anode or a lithium anode.

The electrolyte (c) is not particularly limited and exemplary electrolytes may be NaClO₄ in tetraglyme, NaCF₃SO₃ in tetraglyme or combinations thereof.

The electrolyte (c) may have a concentration in the range of about 0.1 M to about 2 M; about 0.5 M to about 2 M; about 1 M to about 2 M; about 1.5 M to about 2 M; about 0.1 M to about 1.5 M; about 0.1 M to about 1 M or about 0.1 M to about 0.5 M. The electrolyte may have a concentration of 1 M.

The electrochemical cell may have a coulombic efficiency in the range of about 99% to about 100%; about 99.2% to about 100%; about 99.4% to about 100%; about 99.6% to about 100%; about 99.8% to about 100%; about 99% to about 99.8%; about 99% to about 99.6%; about 99% to about 99.4% or about 99% to about 99.2% on average. The coulombic efficiency of the electrochemical cell may be 99.4% on average.

The electrochemical cell may maintain a specific capacity of at least 1000 mAh/g at a charge/discharge cycle of at least 200.

The electrochemical cell may maintain the specific capacity in the range of about 1100 mAh/g to about 1200 mAh/g; about 1120 mAh/g to about 1200 mAh/g; about 1140 mAh/g to about 1200 mAh/g; about 1160 mAh/g to about 1200 mAh/g; about 1180 mAh/g to about 1200 mAh/g; about 1100 mAh/g to about 1180 mAh/g; about 1100 mAh/g to about 1160 mAh/g; about 1100 mAh/g to about 1140 mAh/g or about 1100 mAh/g to about 1120 mAh/g at the 50^{th} charge/discharge cycle at 0.1 C. The electrochemical cell has a specific capacity of about 1185 mAh/g at the 50^{th} charge/discharge cycle at 0.1 C.

The electrochemical cell may maintain the specific capacity in the range of about 1000 mAh/g to about 1200 mAh/g; about 1050 mAh/g to about 1200 mAh/g; about 1100 mAh/g to about 1200 mAh/g; about 1150 mAh/g to about 1200 mAh/g; about 1000 mAh/g to about 1150 mAh/g; about 1000 mAh/g to about 1100 mAh/g or about 1000 mAh/g to about 1050 mAh/g at the 200^{th} charge/discharge cycle at 0.2 C. The electrochemical cell may have a specific capacity of about 1050 mAh/g at the 200^{th} charge/discharge cycle at 0.2 C.

The porous carbon-sulfur composite as a cathode, as defined herein, in conjunction with a sodium anode can be used to form a room-temperature sodium sulfur battery.

### BRIEF DESCRIPTION OF DRAWINGS

The accompanying drawings illustrate a disclosed embodiment and serves to explain the principles of the disclosed embodiment. It is to be understood, however, that the drawings are designed for purposes of illustration only, and not as a definition of the limits of the invention.

[FIG. 1] shows X-ray diffraction (XRD) patterns of Carbon-900 and Carbon-900-S at various processing steps and sulfur powder. The curves are (a) Carbon-900, (b) pure sulfur powder (S₈), (c) mixture of Carbon-900 with sulfur powder but before heating of the mixture, (d) product obtained after mixing and heating of Carbon-900 and sulfur powder, (e) Carbon-900-S.

[FIG. 2] shows TGA analysis of the Carbon-900-S composite indicating sulfur contents, after (a) mixing the porous carbon with sulfur at a weight ratio of 1:3 by grinding; (b) after melt diffusion but without surface sulfur removal by heating; (c) after heat removal of excess surface sulfur.

[FIG. 3] is a schematic diagram of a fabricated sodium-sulfur battery 300 comprising of 2032-type coin cell cases 2, a carbon-sulfur composite cathode 4, a separator 6 and a sodium anode 8.

[FIG. 4] shows (a) Galvanostatic charge/discharge curves at 0.1 C, (b) cycling performance of sodium-sulfur coin cells with the Carbon-900-S composite cathode using 1 M NaClO₄ in tetraglyme as the electrolyte and (c) Cycling performances of sodium-sulfur coin cells using the Carbon-S-900 composite cathode and control samples.

[FIG. 5] shows the influence of the carbonizing temperature of the porous carbon on the sodium-sulfur battery performance.

FIG. 5a shows the cycling performance of sodium-sulfur coin cells with various Carbon-S composites cathode at 0.1 C in 1 M NaClO₄ in tetraglyme electrolytes.

FIG. 5b shows the cycling performance of sodium-sulfur coin cells with various Carbon-S composites cathode at 0.2 C in 1 M NaOTf in tetraglyme electrolytes.

FIG. 5c shows cycling performance of sodium-sulfur batteries with various carbon-S composites cathodes at various current rates in 1 M NaClO₄ in tetraglyme electrolyte.

### EXAMPLES

Non-limiting examples of the invention and a comparative example will be further described in greater detail by reference to specific Examples, which should not be construed as in any way limiting the scope of the invention.

### Example 1

### Synthesis of Porous Carbon-Sulfur Composites

In this example, a three-step procedure for the synthesis of porous carbon-sulfur composites is described.

In the first step, a precursor ZIF-8 was synthesized as follows. Typically, 20 g of 2-methylimidazole (purchased from Sigma Aldrich, Singapore) and 8.4 g of Zn(NO₃)₂.6H₂O (purchased from Sigma Aldrich, Singapore) were dissolved in 250 and 150 mL of methanol (purchased from Sigma Aldrich, Singapore) separately, followed by mixing with vigorous stirring at about 800 rpm for 5 minutes at 25° C.

The mixture was then left at room temperature overnight without disturbance to form a white product. The white product was purified by 3 times centrifugation in about 100 mL of methanol at 5000 rpm for 5 minutes and dried at 80° C. overnight in a vacuum oven.

The dried product was carbonized in a tube furnace at various temperatures and durations under argon flow at 200 sccm to produce a porous carbon. The carbonizing temperatures and durations used were 800° C. for 2 hours, 900° C. for 4 hours or 1000° C. for 8 hours with a heating rate of 2° C. min⁻¹. A range between 800° C. and 1000° C. was selected to study the influence of the carbonizing temperature. The products synthesized at carbonizing temperatures of 800, 900 and 1000° C. were denoted as Carbon-800, Carbon-900 and Carbon-1000, respectively. Porosity and surface areas of the three products were obtained by gas sorption analysis, using both nitrogen (N₂) gas at 77 K, and carbon dioxide (CO₂) gas at 273 K. Surface area was determined by the Brunauer-Emmett-Teller (BET) method.

TABLE 1
Summary of porosity and surface areas of porous carbons produced
for cathode preparation, based on gas sorption analysis.

| | N₂ sorption data, 77 K | | CO₂ sorption data, 273 K |
|---|---|---|---|
| | BET | Average | Total area in |
| | surface area | pore radius | pores >0.4 nm |
| T (° C.) | (m²/g) | (nm) | (m²/g) |
| Carbon-800 | 591 | 4.10 | 903 |
| Carbon-900 | 753 | 3.89 | 864 |
| Carbon-1000 | 800 | 1.38 | 945 |

An acid washing step was also used for removing residual Zn, specifically for the sample carbonized at 800° C. for 2 hours, as this carbonizing temperature was insufficient for complete removal of zinc. The acid washing step consisted of using 50 mL of HCl (purchased from Sigma Aldrich, Singapore) at 2 M to wash the product after carbonizing 1 time, followed by using 50 mL of NaOH (purchased from Sigma Aldrich, Singapore) at 2 M to wash the product 1 time and then rinsing with 50 mL of water 3 times. The product from the acid washing step was collected after drying overnight in an oven at 80° C.

In the second step, a sulfur melt diffusion was performed. Elemental sulfur (S₈, purchased from Sigma Aldrich, Singapore) and the porous carbon were mixed in a weight ratio of 3:1 by pestle and mortar. The mixture was then transferred into stainless steel vessels and sealed, followed by heating at 155° C. for 16 hours to accomplish the sulfur melt diffusion.

In the third step, a black product after the sulfur melt diffusion step was placed in a tube furnace and heated to 250° C. and held for 3 hours with argon flow at a flow rate of 200 sccm to remove excess residual sulfur on the surface of the black product. The resulting porous carbon-sulfur composites synthesized at carbonizing temperatures of 800, 900 and 1000° C. were denoted as Carbon-800-S, Carbon-900-S and Carbon-1000-S, respectively.

Three control samples were also produced. Firstly, the Carbon-800-S-Control was produced, without the acid washing step to inspect the influence of residual Zn in the porous carbon. More importantly, for evaluating the importance of surface sulfur removal in the third step, two control samples Carbon-900-S-Control 1 and Carbon-900-S-Control 2 were also produced, in which the weight ratio of carbon to sulfur in the second step were set as 45/55 and 25/75, respectively. These mixtures were treated with the second step but not the third step.

TABLE 2
Summarization of porous carbon-sulfur composites
produced for cathodes preparation.

| | | | Acid | Presence | Presence |
|---|---|---|---|---|---|
| | Carbonizing | | Washing for | of the | of the |
| Sample Name | Temperature | | Residual Zinc | Second Step | Third Step |
| Carbon-800-S | 800° | C. | Yes | Yes | Yes |
| Carbon-900-S | 900° | C. | No | Yes | Yes |
| Carbon-1000-S | 1000° | C. | No | Yes | Yes |
| Carbon-800-S- | 800° | C. | No | Yes | Yes |
| Control | | | | | |
| Carbon-900-S- | 900° | C. | No | Yes | No |
| Control 1 | | | | | |
| Carbon-900-S- | 900° | C. | No | Yes | No |
| Control 2 | | | | | |

### Example 2

### Confirmation of Sulfur Embedding in Porous Carbon-Sulfur Composites

To exemplify the importance of the additional heating process for excess sulfur removal in the present disclosure, X-ray diffraction (XRD), elemental combustion analysis, and thermogravimetric analysis (TGA) were used to track the changes in sulfur content throughout the sulfur introduction process, based on the second and the third step as described in Example 1.

The confirmation of sulfur embedment within the porous carbon structure was achieved with XRD. For comparison, XRD spectra of the Carbon-900 sample are shown in FIG. 1 at the various processing stages: Carbon-900 mixed with sulfur in the second step before the heating step and after the heating step, and Carbon-900-S after the third step of sulfur removal. Pure Carbon-900 and pure elemental sulfur are also shown for comparison.

The Carbon-900 sample mixed with sulfur in the second step before the heating step showed the same distinctive pattern as pure elemental sulfur. After the heating step, new patterns appeared (marked with star symbol in FIG. 1) owing to the partial phase transition of sulfur from orthorhombic to monoclinic after 155° C. heating treatment. Nonetheless, the high intensity of the sulfur peaks indicate the presence of surface sulfur.

However, after the third step of surface sulfur removal, the XRD pattern of the Carbon-900-S composite showed two broad peaks at around 23 and 44°, corresponding only to the reflections of the (002) and (100) planes of graphitized carbon, similar to the starting Carbon-900. No diffraction peaks of sulfur were observed, confirming that all sulfur was embedded deep within the pores, and not existing on the surface.

Additionally, TGA was also useful in elucidating changes in the nature of sulfur, either embedded within the pores or otherwise on the surface. The processing of Carbon-900-S composite was selected as an example to study the features of sulfur via TGA investigation, which were illustrated in FIG. 2, the weight loss profiles of samples after the treatment procedure indicate that the heating process in the second step at 155° C. in a small vessel was essential for the sulfur injection, with sulfur outgassing starting at a significantly higher temperature (curve b) as compared to the sample from physical grinding (curve a). More importantly, two new gradient changes in curve b with higher outgas temperatures suggested the existence of new sulfur species due to stronger interaction with carbon, likely from confinement within the microporous structure. After surface sulfur removal (curve c), the sulfur content in the Carbon-900-S composite was calculated to be around 36%.

In this example, the disappearance of elemental sulfur from the porous carbon-sulfur composite was confirmed from XRD (FIG. 1). Despite the loss of spectral information for elemental sulfur in the composite (curve (e): Carbon-900-S), elemental combustion analysis indicated that sulfur was still present in the composite at about 35 weight %, albeit as a different allotrope (Table 3). This was corroborated with TGA data (curve (c) in FIG. 2) showing similar weight loss.

In addition, gradient changes in curve (b) of FIG. 2 with higher outgas temperatures were associated with short-chain allotropes, as they were confined within the porous structure and may only be outgassed from the composite at higher temperatures.

### Example 3

### Effect of the Carbonizing Temperature on Porous Carbon-Sulfur Composites

Porous carbon-sulfur composites were synthesized at various carbonizing temperatures based on Example 1. Targeting to understand the carbonizing temperature influence on the various carbon-sulfur composites as cathode materials, elemental analysis was performed on the carbon-sulfur composites. The sulfur contents were around 35% to 39%, consistent with the TGA measurement. As a reference, sulfur compositions in porous carbon composites typically ranged between 30% and 40%.

TABLE 3
Elemental compositions of porous carbon-sulfur composites
determined by combustion elemental analysis.

| | | | | | Carbon/ |
|---|---|---|---|---|---|
| | Elemental Composition (weight %) | | | | Nitrogen Ratio |
| Sample Name | C | H | N | S | (mol/mol) |
| Carbon-800-S | 40.95 | 0.74 | 13.01 | 35.6 | 3.67 |
| Carbon-900-S | 43.62 | 0.48 | 5.16 | 35.2 | 9.86 |
| Carbon-1000-S | 51.05 | 0.18 | 2.76 | 39.5 | 21.58 |

Specifically, the carbon/nitrogen ratio increased monotonically with the carbonizing temperature (Table 3). It has been shown in the prior arts that nitrogen doping could improve the conductivity of materials and hinder the shuttle effect of polysulfides, thus improving the cycling stability and rate performance. It was supposed that an optimal carbon/nitrogen ratio would lead to the best sodium-sulfur battery performance.

### Example 4

### Fabrication of Full Cell Consisting of Porous Carbon-Sulfur Composite Cathode and Sodium Anode

In this example, the composite material made in Example 1 was used to make a cathode.

To make the cathode, the porous carbon-sulfur composite, conductive carbon (Super P, purchased from Alfa Aesar, Singapore), and polyvinylidene fluoride (PVDF, purchased from Sigma Aldrich, Singapore) were ground in an agate mortar in a weight ratio of 7:2:1 with N-Methyl-2-pyrrolidone (NMP, purchased from Sigma Aldrich, Singapore solvent to yield a viscous slurry, which was stirred in a small vial at about 600 rpm at 25° C. overnight. Finally, the slurry was coated onto carbon-coated aluminium foil (purchased from MTI Corporation, USA) with a doctor blade (80 mm width, 50 μm to 400 μm variable coating thickness, purchased from MTI Corporation, USA) and allowed to dry completely at 60° C. overnight.

An electrochemical cell such as in FIG. 3 was made whereby the cell 300 comprises of 2032-type coin cell cases 2, a carbon-sulfur composite cathode 4, a separator 6 and a sodium anode 8.

Sodium-sulfur cells were fabricated as 2032-type coin cells in an argon-filled glovebox with the porous carbon-sulfur composite as the cathode (11.28 mm in diameter), freshly cut sodium circular discs (12.7 mm in diameter, 99.9% purity, purchased from Sigma Aldrich, Singapore) as the anode, and Celgard 2325 membrane (purchased from Celgard, USA) as the separator. Electrolytes used were 25 μL of 1 M sodium perchlorate (NaClO₄, purchased from Sigma Aldrich, Singapore) or 1 M sodium triflate (NaCF₃SO₃ or NaOTf, purchased from Solvionic, France) in tetraglyme (an ether, purchased from Sigma Aldrich, Singapore).

### Example 5

### Importance of the Surface Excess Sulfur Removal of the Porous Carbon-Sulfur Composite on the Sodium-Sulfur Battery Performance

To investigate the performance of the batteries operating at room temperature, galvanostatic discharge-charge cycling tests were performed at 0.1 or 0.2 C (1 C=1673 mAg(s)⁻¹).

FIGS. 4a and 4b illustrated the charge/discharge profiles of the Carbon-900-S cathode in a 1 M NaClO₄ in tetraglyme electrolyte, and the corresponding capacity profiles and Coulombic efficiencies. In the first discharge cycle, the measured specific capacity of the battery was 1585 mAh/g, close to the theoretical value of sulfur (1673 mAh/g). The specific capacity of the second discharge cycle dropped to 1439 mAh/g and gradually decayed with a decline rate of 0.49% per cycle in the following 50 discharge cycles. The specific capacity maintained a stable value of 1185 mAh/g at the 50^{th} charge/discharge cycle. Thus, the Carbon-900-S composites worked well in the ether-based electrolyte.

In FIG. 4c, the coin cell using the Carbon-900-S-Control 1 and the Carbon-900-S-Control 2 cathodes were compared with the coin cell using the Carbon-900-S cathode. The Carbon-900-S-Control 2 cathode had the same initial carbon/sulfur weight ratio as the Carbon-900-S cathode and the Carbon-900-S-Control 1 cathode had a higher initial carbon/sulfur weight ratio. Both had residual sulfur on the surface of the porous carbon, resulting in poor battery performance.

Moreover, the additional step of heating under argon atmosphere to remove excess sulfur on the surface was important for the high cycling stability of the sodium-sulfur batteries. This step ensured that all the sulfur was encapsulated in the pores instead of being on the surface of the composite. As shown in FIG. 4c, without removal of excess surface sulfur, the capacity declined quickly even within the first two charge/discharge cycles. The more surface excess sulfur existed, the worse specific capacity achieved.

### Example 6

### Influence of Carbonizing Temperature of the Porous Carbon on the Sodium-Sulfur Battery Performance

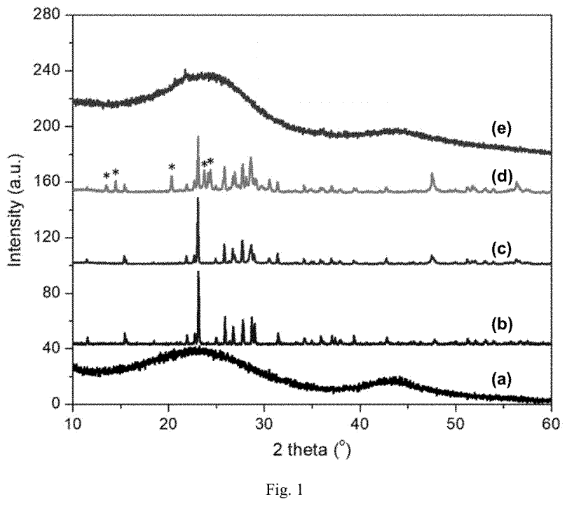

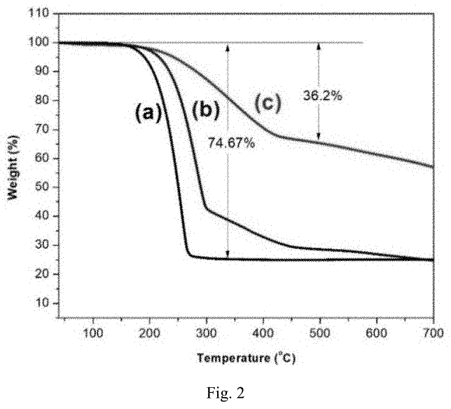

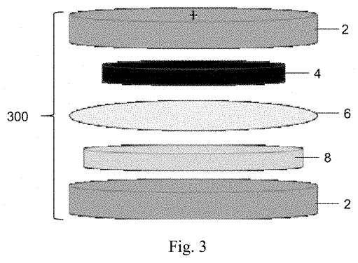

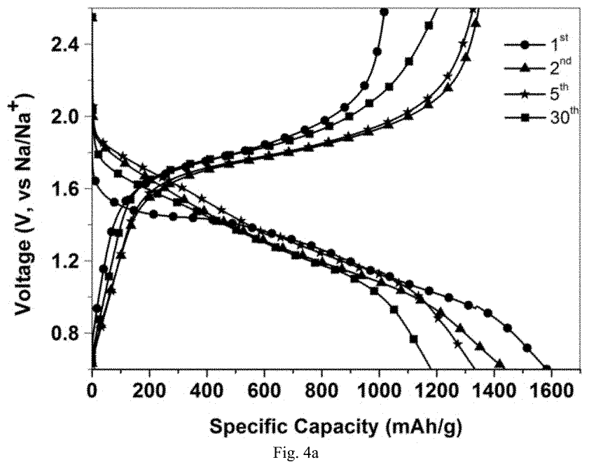

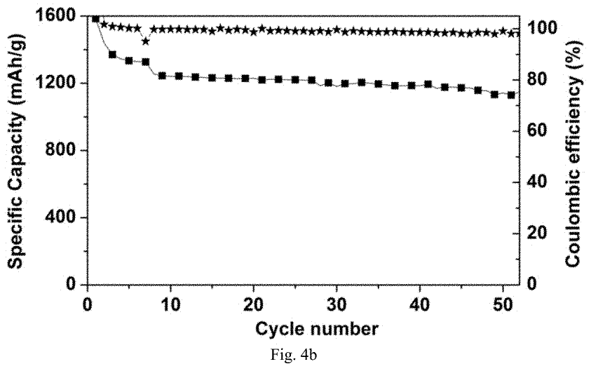

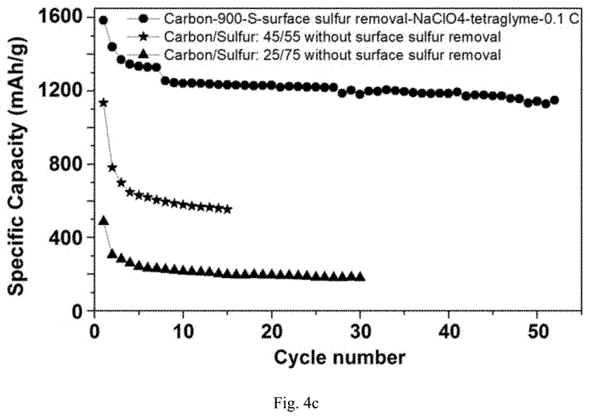

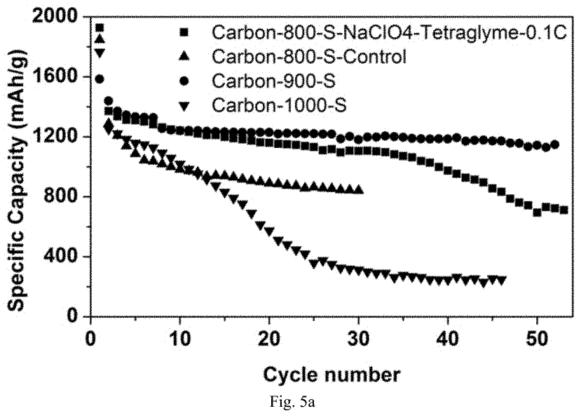

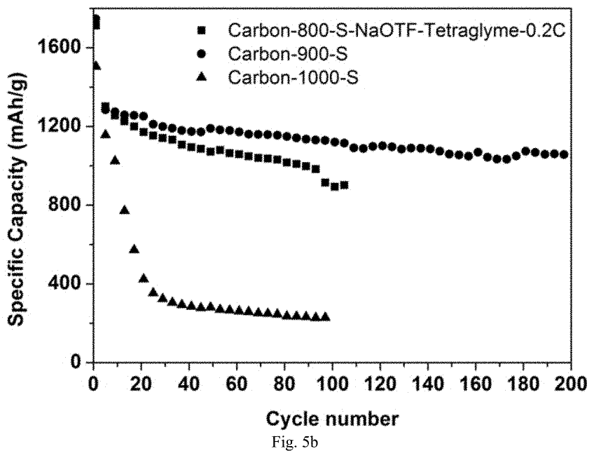

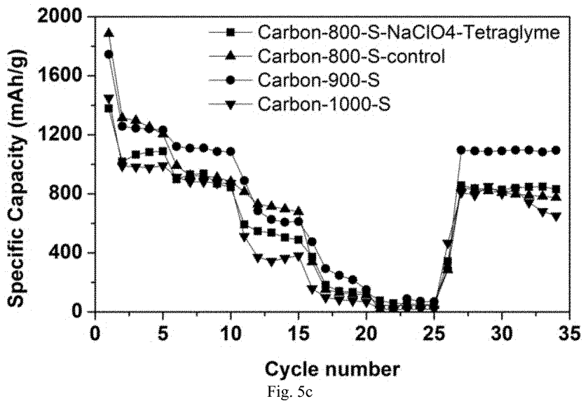

To investigate overall sodium-sulfur battery performance, carbon-sulfur composites prepared under different carbonizing temperatures were tested in various electrolyte/solvent combinations at various current rates (FIG. 5). Overall, the Carbon-900-S composites showed the best performance under the various conditions tested (FIGS. 5a and 5b). At 0.1 C, the Carbon-900-S electrodes exhibited the highest specific capacity and cycling stability in the tetraglyme electrolyte, while Carbon-1000-S electrodes performed the poorest.

Moreover, the Carbon-900-S battery exhibited stable cycling performance over 200 charge/discharge cycles, and can maintain a specific capacity of 1050 mAh/g at the 200^{th} charge/discharge cycle at 0.2 C in the tetraglyme electrolyte (FIG. 5b). Carbon-900-S also showed the highest specific capacity at various current rates (0.1 to 2 C) and maintained the best stability (FIG. 5c).

It should be emphasized that, at lower carbonizing temperature (800° C.), additional treatment of the carbon product with the acid washing step to etch away residual zinc was essential since the trace amount of zinc would degrade the battery performance badly, which could be overcome by increasing the carbonizing temperature to 900° C. (zinc will evaporate out from the porous carbon since the boiling point of bulk zinc is 907° C.) (FIG. 5a, 5c).

### INDUSTRIAL APPLICABILITY

The porous carbon-sulfur composite may be used as an electrode and may be used in a variety of applications such as coin cells, batteries, energy storage devices, biosensors, implantable electrodes or an electrode in capacitors or organic microelectronics.

The sodium-sulfur battery may be used in smart windows, in electrochromic devices, in sensors for organic and bio-organic materials, in field effect transistors or in printing plates.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1. A method of synthesizing a porous carbon-sulfur composite, comprising the steps of:
(a) carbonizing a carbon material having a metal-organic framework at a temperature in the range of 800° C. to 1000° C. to produce a porous carbon;
(b) mixing and heating the porous carbon with sulfur to infuse said sulfur into the pores of said porous carbon; and
(c) removing excess sulfur not infused into the pores or present on the surface of said porous carbon.

2. The method of claim 1, wherein the temperature for the carbonizing step (a) is at least 900° C. to less than 1000° C.

3. The method of claim 1, wherein the metal-organic framework of the carbon material is selected from the group consisting of zeolite-type metal-organic frameworks, micro-porous metal-organic framework (MMOFs), porous coordination networks (PCNs) and porous coordination polymers (PCPs).

4. The method of claim 3, wherein the zeolite-type metal-organic framework is selected from the group consisting of zeolitic imidazolate framework-3 (ZIF-3), zeolitic imidazolate framework-6 (ZIF-6), zeolitic imidazolate framework-8 (ZIF-8), zeolitic imidazolate framework-11 (ZIF-11), zeolitic imidazolate framework-14 (ZIF-14), zeolitic imidazolate framework-20 (ZIF-20), zeolitic imidazolate framework-60 (ZIF-60), zeolitic imidazolate framework-68 (ZIF-68) and zeolitic imidazolate framework-95 (ZIF-95).

5. The method of claim 1, wherein the method does not comprise a washing step after the carbonizing step (a).

6. The method of claim 1, wherein the sulfur infused into the pores of said porous carbon in step (b) is short-chain sulfur allotropes S₂, S₃ or S₄ and the excess sulfur not infused into the pores or present on the surface of said porous carbon in step (c) is elemental sulfur S₈.

7. The method of claim 1, wherein in the mixing and heating step (b), the sulfur and porous carbon are provided in a weight ratio in the range of 5:1 to 1:1.

8. The method of claim 1, wherein the removing step (c) comprises evaporating the excess sulfur under an inert gas flow in an open system.

9. A porous carbon-sulfur composite synthesized by a method comprising the steps of:
(a) carbonizing a carbon material having a metal-organic framework at a temperature in the range of 800° C. to 1000° C. to produce a porous carbon;
(b) mixing and heating the porous carbon with sulfur to infuse said sulfur into the pores of said porous carbon; and
(c) removing excess sulfur not infused into the pores or present on the surface of said porous carbon.

10. The porous carbon-sulfur composite of claim 9, wherein the composite has a weight percentage of sulfur in the range of 30 weight % to 40 weight % based on the porous carbon-sulfur composite, or
wherein the composite has a weight ratio of carbon and nitrogen in the range of 20:1 to 3:1.

11. (canceled)

12. The porous carbon-sulfur composite of claim 9, wherein the composite has a sulfur content consisting essentially of S₂, S₃, S₄ and combinations thereof.

13. A cathode comprising a porous carbon-sulfur composite synthesized by a method comprising the steps of:
(a) carbonizing a carbon material having a metal-organic framework at a temperature in the range of 800° C. to 1000° C. to produce a porous carbon;
(b) mixing and heating the porous carbon with sulfur to infuse said sulfur into the pores of said porous carbon; and
(c) removing excess sulfur not infused into the pores or present on the surface of said porous carbon.

14. A method of preparing a cathode comprising a porous carbon-sulfur composite synthesized by a method comprising the steps of:
(i) carbonizing a carbon material having a metal-organic framework at a temperature in the range of 800° C. to 1000° C. to produce a porous carbon;
(ii) mixing and heating the porous carbon with sulfur to infuse said sulfur into the pores of said porous carbon; and
(iii) removing excess sulfur not infused into the pores or present on the surface of said porous carbon,
comprising the steps of:
(a) mechanically treating a mixture comprising the porous carbon-sulfur composite a conductive carbon, and a polymer binder;
(b) adding an organic solvent into the mixture to yield a slurry; and
(c) coating the slurry onto a carbon-coated aluminium foil.

15. The method of claim 14, wherein the mechanically treating step (a) comprises mixing the porous carbon-sulfur composite, the conductive carbon and the polymer binder at a weight ratio of about 7:2:1.

16. The method of claim 14, wherein the adding step (b) further comprises stirring the slurry overnight.

17. The method of claim 14, further comprising a drying step after the coating step (c); wherein the drying step is performed under a temperature in the range of 40° C. to 80° C.

18. An electrochemical cell comprising:
(a) a cathode comprising a porous carbon-sulfur composite synthesized by a method comprising the steps of:
(i) carbonizing a carbon material having a metal-organic framework at a temperature in the range of 800° C. to 1000° C. to produce a porous carbon;
(ii) mixing and heating the porous carbon with sulfur to infuse said sulfur into the pores of said porous carbon; and
(iii) removing excess sulfur not infused into the pores or present on the surface of said porous carbon;
(b) an anode; and
(c) an electrolyte in fluid communication with both said cathode and said anode.

19. The electrochemical cell of claim 18, further comprising a separator.

20. The electrochemical cell of claim 18, wherein the anode is a sodium anode or a lithium anode, or
wherein the electrolyte is NaClO₄ in tetraglyme, NaCF₃SO₃ in tetraglyme or a combination thereof.

21. (canceled)

22. The electrochemical cell of claim 18, wherein the electrolyte has a concentration in the range of 0.1 M to 2 M.
